(19) United States
(12) Patent Application Publication
(10) Pub. No.: US 2025/0202318 A1
(43) Pub. Date: Jun. 19, 2025

(54) DRIVING MOTOR COOLING SYSTEM AND CONTROL METHOD FOR THE SAME

(71) Applicants: HYUNDAI MOTOR COMPANY, SEOUL (KR); KIA CORPORATION, SEOUL (KR)

(72) Inventors: Hyung Kwan Jang, Uijeongbu-si (KR); Hoo Dam Lee, Seoul (KR); Kyung Sik Choi, Seoul (KR); Jun Hyeok Choi, Suwon-si (KR); Byung Ho Min, Suwon-si (KR); Tae Gyu Lee, Seoul (KR)

(73) Assignees: HYUNDAI MOTOR COMPANY, SEOUL (KR); KIA CORPORATION, SEOUL (KR)

(21) Appl. No.: 18/657,014

(22) Filed: May 7, 2024

(30) Foreign Application Priority Data
Dec. 18, 2023 (KR) 10-2023-0184668

(51) Int. Cl. H02K 9/193; H02K 9/197; H02K 11/25

(52) U.S. Cl. CPC H02K 9/193; H02K 9/197; H02K 11/25

(57) ABSTRACT

A driving motor cooling system includes a storage tank configured to store a cooling medium therein, a cooling case configured to surround an outer circumferential surface of a normal conduction driving motor while being formed with a flow space configured to allow the cooling medium to flow therein and formed with inlet and outlet pipes for the cooling medium configured to connect the flow space to an outside, a cooling line configured to interconnect the storage tank and the inlet pipe, thereby allowing the cooling medium to be supplied to the cooling case, a control valve provided at the cooling line, and a controller including a memory storing a reference temperature while being configured to control the control valve through comparison of a temperature of the driving motor with the reference temperature, thereby controlling cooling of the driving motor through the cooling medium.

### CROSS REFERENCE TO RELATED APPLICATIONS

This application claims priority from Korean Patent Application No. 10-2023-0184668 filed on Dec. 18, 2023 in the Korean Intellectual Property Office, the disclosure of which is incorporated herein by reference in its entirety.

### BACKGROUND

### 1. Field

The present disclosure relates to a cooling system for cooling a driving motor and a control method for the same, and more particularly to a cooling system using a cryogenic refrigerant and a control method for the same.

### 2. Description of the Related Art

A driving motor is electric power equipment most easily accessible in our daily life. A variety of driving motors are equipped in home appliances such as a refrigerator, a laundry machine, a vacuum cleaner, an air conditioner, etc. Such a driving motor is also used in a vehicle as an essential core element, and also performs an important function in large means of transportation such as a ship, an airplane, a train, or the like.

In association with such application, enhancing the efficiency of the driving motor is a global important task. This is because electrical energy consumed by the driving motor occupies 45% or more of the total power consumption of an appliance in which the driving motor is equipped and, as such, it may be possible to prevent waste of electrical energy and to achieve environmental protection through an enhancement in efficiency of the driving motor.

As a method of enhancing the efficiency of the driving motor, there is, for example, a method of effectively cooling the drive motor. In detail, as the temperature of the driving motor is decreased, characteristics of a material used in the driving motor may be enhanced and, as such, excellent results of the driving motor such as a reduction in size, an enhancement in specific output, an enhancement in efficiency, etc. may be obtained.

Furthermore, there may be use of a superconducting motor as a most reliable solution capable of achieving an enhancement in efficiency of a driving motor. A superconducting phenomenon means that electrical resistance interfering flow of electric current completely disappears at a critical temperature or less. In the superconducting motor, a superconducting wire is substituted for a coil of an electric motor. When a motor is configured to utilize a superconducting phenomenon, high magnetization may be realized and, as such, a high-capacity motor may be easily realized. Furthermore, state-of-the-art motor technology capable of achieving miniaturization, lightness, high output, and high efficiency of a motor may be realized.

The above matters disclosed in this section are merely for enhancement of understanding of the general background of the disclosure and should not be taken as an acknowledgement or any form of suggestion that the matters form the related art already known to a person skilled in the art.

### SUMMARY

Therefore, the present disclosure has been made in view of the above problems, and it is an object of the present disclosure to provide a driving motor cooling system using a cryogenic refrigerant and a control method for the same.

It is another object of the present disclosure is to provide a driving motor cooling system and a control method for the same which are capable of achieving an enhancement in efficiency of a driving motor through effective cooling of a stator of the driving motor through a configuration in which a cooling case surface-contacts the stator of the driving motor in a circumferential direction, effectively cooling the driving motor through control of a flow rate of a cooling medium according to a temperature of the driving motor when the driving motor is a normal conduction driving motor, and enabling a superconducting phenomenon to be effectively exhibited when the driving motor is a superconducting driving motor.

In accordance with an aspect of the present disclosure, the above and other objects can be accomplished by the provision of a driving motor cooling system including a storage tank configured to store a cooling medium therein, a cooling case configured to surround an outer circumferential surface of a normal conduction driving motor while being formed with a flow space configured to allow the cooling medium to flow therein and formed with inlet and outlet pipes for the cooling medium configured to connect the flow space to an outside, a cooling line configured to interconnect the storage tank and the inlet pipe, thereby allowing the cooling medium to be supplied to the cooling case, a control valve provided at the cooling line, and a controller including a memory storing a reference temperature while being configured to control the control valve through comparison of a temperature of the normal conduction driving motor with the reference temperature, thereby controlling cooling of the normal conduction driving motor through the cooling medium.

The cooling case may be installed to directly contact a stator of the normal conduction driving motor or to be adjacent to the stator.

The stator of the normal conduction driving motor may be disposed inside a rotor of the normal conduction driving motor, and the cooling case may be inserted into an interior of the stator of the normal conduction driving motor.

When the temperature of the normal conduction driving motor is not higher than the reference temperature, the controller may control a part of the control valve at a side of the normal conduction driving motor to reduce an amount of the cooling medium supplied to the cooling case.

The reference temperature may be −200° C. to 50° C.

The inlet pipe may be formed at an end of one side of the cooling case, and the outlet pipe may be formed at an end of the other side of the cooling case opposing the end of the one side of the cooling case.

The cooling medium stored in the storage tank may be selected from a group consisting of liquified hydrogen, liquified nitrogen, liquified helium, liquefied argon, and liquified methane.

The cooling medium stored in the storage tank may be liquefied hydrogen. The driving motor cooling system may further include a fuel cell provided at a side downstream of the normal conduction driving motor and configured to generate driving force using hydrogen gas phase-changed while cooling the normal conduction driving motor, and a fuel line connected to the outlet pipe of the cooling case and configured to supply, to the fuel cell, the hydrogen gas phase-changed through heat exchange with the normal conduction driving motor.

The driving motor cooling system may further include a branch line connected to the fuel line after being branched from the control valve of the cooling line and provided with a heat exchanger configured to receive liquified hydrogen from the storage tank and then to vaporize the liquified hydrogen.

A heating line may be branched from the branch line at a side upstream of the heat exchanger in order to guide hydrogen used to cool the normal conduction driving motor such that the hydrogen is introduced into the heat exchanger. A heating valve may be provided at the fuel line at a side upstream of the fuel cell, and the heating line may be connected to the fuel line via the heating valve.

Upon determining that a temperature of the cooling medium used to cool the normal conduction driving motor is lower than a critical temperature, the controller may close a fuel cell-side part of the heating valve and may open a heat exchanger-side part of the heating valve, thereby allowing the cooling medium used to cool the normal conduction driving motor to be introduced into the heat exchanger.

The critical temperature may be a boiling point of hydrogen (−252.7° C.).

The controller may control the control valve such that the branch line connected to the heat exchanger is always opened.

In accordance with another aspect of the present disclosure, there is provided a driving motor cooling system including a storage tank configured to store a cooling medium therein, a cooling case configured to surround an outer circumferential surface of a driving motor while being formed with a flow space configured to allow the cooling medium to flow therein and formed with inlet and outlet pipes for the cooling medium configured to connect the flow space to an outside, a cooling line configured to interconnect the storage tank and the inlet pipe, thereby allowing the cooling medium to be supplied to the cooling case, a control valve provided at the cooling line, and a controller including a memory storing a reference temperature, the controller being configured to control the control valve to always open the cooling line connected to the driving motor when the driving motor is a superconducting driving motor, the controller being configured to control the control valve through comparison of a temperature of the driving motor with the reference temperature, thereby controlling cooling of the driving motor through the cooling medium, when the driving motor is a normal conduction driving motor.

In accordance with another aspect of the present disclosure, there is provided a control method for a driving motor cooling system including a cooling medium storage tank, a cooling case configured to surround an outer circumferential surface of a normal conduction driving motor while being formed with a flow space therein and formed with inlet and outlet pipes for the cooling medium configured to connect the flow space to an outside, a cooling line configured to interconnect the storage tank and the inlet pipe, a control valve provided at the cooling line, and a controller configured to control the control valve, the control method including receiving, by the controller, a temperature of the normal conduction driving motor, comparing, by the controller, the temperature of the normal conduction driving motor with a reference temperature stored in a memory, and controlling, by the controller, the control valve in accordance with results of comparison between the temperature of the normal conduction driving motor and the reference temperature stored in the memory, thereby controlling cooling of the driving motor.

When the temperature of the normal conduction driving motor is not higher than the reference temperature in the controlling cooling, the controller may close a part of the control valve at a side of the normal conduction driving motor.

The reference temperature stored in the memory may be −200° C. to 50° C.

The cooling medium may be liquid hydrogen. The driving motor cooling system may further include a fuel cell provided at a side downstream of the normal conduction driving motor and configured to generate driving force using hydrogen gas phase-changed while cooling the normal conduction driving motor, a fuel line connected to the outlet pipe of the cooling case and configured to supply, to the fuel cell, the hydrogen gas phase-changed through heat exchange with the normal conduction driving motor, a branch line connected to the fuel line after being branched from the control valve of the cooling line and provided with a heat exchanger configured to receive liquified hydrogen from the storage tank and then to vaporize the liquified hydrogen, and a heating line branched from the branch line at a side upstream of the heat exchanger and connected to a heating valve provided at the fuel line. The control method may further include controlling, by the controller, the heating valve based on a temperature of the cooling medium used to cool the normal conduction driving motor after the controlling cooling.

Upon determining that the temperature of the cooling medium is lower than a critical temperature in the controlling the heating valve, the controller may close a fuel cell-side part of the heating valve and may open a heat exchanger-side part of the heating valve, thereby allowing the cooling medium used to cool the normal conduction driving motor to be introduced into the heat exchanger.

The critical temperature may be a boiling point of hydrogen (−252.7° C.).

In accordance with the present disclosure, the cooling case surface-contacts the stator of the driving motor in a circumferential direction of the stator and, as such, the area of the cooling case exchanging heat with the stator may be maximized. As a result, cooling efficiency may be maximized. Accordingly, efficiency enhancement, element stability, specific output enhancement, size reduction, etc. of the driving motor may be satisfied.

In addition, it may be possible to appropriately adjust the amount of the cooling medium introduced into the cooling case in accordance with the temperature of the driving motor through the controller. Accordingly, the state of the driving motor may be optimized.

Furthermore, when a fuel cell is used, liquified hydrogen is phase-changed into hydrogen gas through heat exchange thereof with the driving motor, and the hydrogen gas is supplied to the fuel cell. In accordance with such a configuration, it may be possible to not only reduce a load applied to the heat exchanger, but also to efficiently achieve two functions of the liquified hydrogen, that is, cooling of the driving motor and generation of driving force according to supply to the fuel cell.

### BRIEF DESCRIPTION OF THE FIGURES

The above and other objects, features and other advantages of the present disclosure will be more clearly understood from the following detailed description taken in conjunction with the accompanying drawings, in which:

FIG. 1 is a schematic diagram of a driving motor cooling system according to an embodiment of the present disclosure;

FIG. 2 is a view showing a cooling case;

FIGS. 3 and 4 are schematic diagrams of driving motor cooling systems according to other embodiments of the present disclosure, respectively;

FIG. 5 is a flowchart of a control method for a driving motor cooling system according to an embodiment of the present disclosure; and

FIG. 6 is a flowchart of a control method for a driving motor cooling system according to another embodiment of the present disclosure.

### DETAILED DESCRIPTION

Hereinafter, embodiments of the present disclosure will be described in detail with reference to the accompanying drawings, and the same or similar elements are designated by the same reference numerals regardless of the numerals in the drawings and redundant description thereof will be omitted.

In the following description of the embodiments of the present disclosure, a detailed description of known functions and configurations incorporated herein will be omitted when it may obscure the subject matter of the embodiments of the present disclosure. In addition, the embodiments of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms “first,” “second,” etc. may be used herein to describe various elements, these elements should not be limited by these terms. These terms are only used to distinguish one element from another.

Unless clearly used otherwise, singular expressions include a plural meaning.

In this specification, the term “comprising,” “including,” or the like, is intended to express the existence of the characteristic, the numeral, the step, the operation, the element, the part, or the combination thereof, and does not exclude another characteristic, numeral, step, operation, element, part, or any combination thereof, or any addition thereto.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

The controller may include a communication device configured to communicate with another controller or a sensor for control of a function to be performed thereby, a memory configured to store an operating system, logic commands, input/output information, etc., and at least one processor configured to execute discrimination, calculation, determination, etc. required for control of the function to be performed.

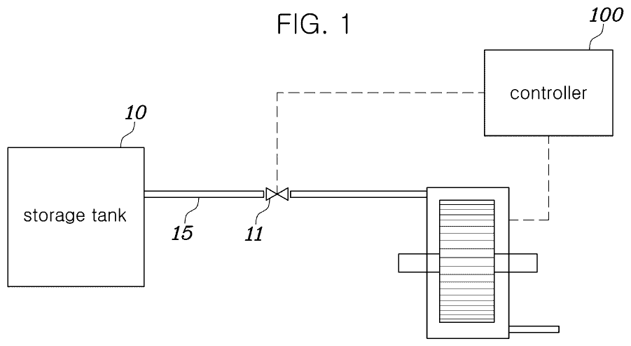

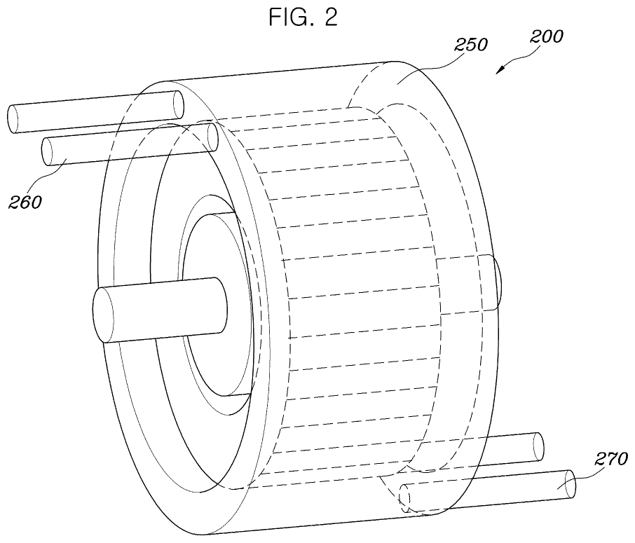

Hereinafter, a cooling system according to an embodiment of the present disclosure will be described with reference to FIG. 1. The cooling system includes a storage tank 10 configured to store a cooling medium, a cooling case 250 (FIG. 2) configured to surround an outer circumferential surface of a normal conduction driving motor 200 while being formed with a flow space configured to allow the cooling medium to flow therein and formed with inlet and outlet pipes 260 and 270 (FIG. 2) for the cooling medium configured to connect the flow space to an outside, a cooling line 15 configured to interconnect the storage tank 10 and the inlet pipe 260, thereby allowing the cooling medium to be supplied to the cooling case 250, a control valve 11 provided at the cooling line 15, and a controller 100 including a memory storing a reference temperature while being configured to control the control valve 11 through comparison of a temperature of the normal conduction driving motor 200 with the reference temperature, thereby controlling cooling of the normal conduction driving motor 200 through the cooling medium.

For element stability, efficiency enhancement, specific output enhancement, etc. of the driving motor 200, it is important to sufficiently cool the driving motor 200. When the driving motor 200 is a normal conduction driving motor, an oil cooling method in which an oil is directly sprayed or dropped onto a coil of a stator, a water cooling method using a cooling water, an air cooling method using air, etc. may be mainly used in order to cool the stator coil.

However, such methods have a limitation in controlling a temperature of the driving motor 200 due to a limitation of the cooling medium. To this end, in the present disclosure, a cryogenic refrigerant is used as the cooling medium for cooling the driving motor 200.

Here, the cryogenic refrigerant may be selected from the group consisting of liquified hydrogen, liquified nitrogen, liquified helium, liquefied argon, and liquified methane. It may be possible to more rapidly cool the driving motor 200 and to cool the driving motor 200 to a desired lower temperature by using the cryogenic refrigerant. Accordingly, it may be possible to accomplish a purpose to achieve size reduction, specific output enhancement, and efficiency enhancement of the driving motor 200.

Next, the cooling case 250 will be described with reference to FIG. 2.

The cooling case 250 may be installed to directly contact the stator of the normal conduction driving motor 200 or to be adjacent to the stator. The cooling case 250 may be formed to surround the outer circumferential surface of the normal conduction driving motor 200. In detail, the cooling case 250 may be installed to directly contact the stator of the normal conduction driving motor 200 or to be adjacent to the stator. Accordingly, the area of the cooling case 250 exchanging heat with the normal conduction driving motor 200 is increased and, as such, the cooling case 250 may have an effect of more rapidly cooling the normal conduction driving motor 200.

In addition, when the stator of the normal conduction driving motor 200 is disposed inside a rotor of the normal conduction driving motor 200, the cooling case 250 may be formed to be inserted into an interior of the stator of the normal conduction driving motor 200. Accordingly, the cooling case 250 according to the embodiment of the present disclosure may be applied not only in the case in which the stator is applied to an outside of the rotor, but also in the case in which the stator is applied to an inside of the rotor.

The inlet pipe 260 configured to receive the cooling medium from the storage tank 10 may be formed at one side of the cooling case 250. The inlet pipe 260 may be connected to the storage tank 10 via the cooling line 15. The amount of the cooling medium introduced from the storage tank 10 may be adjusted as the controller 100 controls the control valve 11 provided at the cooling line 15, as will be described later. In addition, the outlet pipe 270 configured to discharge the cooling medium to an outside may be formed at the other side of the cooling case 250. In this case, a pressure adjustment device may be formed at the other side of the cooling case 250, together with the outlet pipe 270. The interior of the cooling case 250 may be evacuated and, as such, it may be possible to not only prevent generation of ice, but also to enhance cooling performance.

In detail, the inlet pipe 260 may be formed at an end of one side of the cooling case 250, whereas the outlet pipe 270 may be formed at an end of the other side of the cooling case 250 diagonally opposing the end of the one side of the cooling case 250. Since the inlet and outlet pipes 260 and 270 are formed such that the distance therebetween is maximized, the cooling medium supplied to the cooling case 250 may perform maximal heat exchange with the normal conduction driving motor 200 and, as such, cooling efficiency may be maximized.

Next, the controller 100 will be described. The controller 100 stores the reference temperature in the memory thereof. The controller 100 controls the control valve 11 through comparison of a temperature of the normal conduction driving motor 200 with the reference temperature, thereby adjusting an amount of the cooling medium supplied to the cooling case 250. Here, the reference temperature may be in a range of −200 to 50° C. In this case, the reference temperature may be selected between −200° C. and 50° C. in accordance with the material of permanent magnets of the rotor, the constituent elements or structure of the normal conduction driving motor 200, etc.

The controller 100 may receive the temperature of the normal conduction driving motor 200, and may control the control valve 11 to reduce the amount of the cooling medium supplied to the normal conduction driving motor 200 when the temperature of the normal conduction driving motor is lower than the reference temperature. On the other hand, when the temperature of the normal conduction driving motor is higher than the reference temperature, the controller 100 controls the control valve 11 to increase the amount of the cooling medium supplied to the normal conduction driving motor 200.

Since the supply amount of the cooling medium may be adjusted in accordance with the temperature of the normal conduction driving motor 200 through the controller 100, the normal conduction driving motor 200 may be maintained at an optimal temperature.

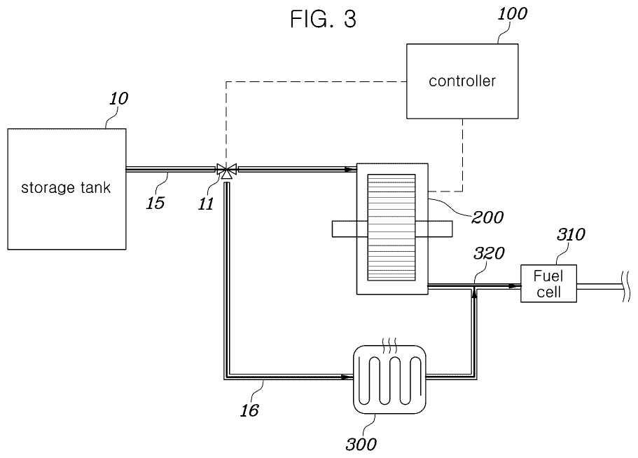

Meanwhile, FIG. 3 shows a driving motor cooling system according to another embodiment of the present disclosure. The other embodiment of the present disclosure is suitable for the case in which liquified hydrogen is used as a cooling medium.

Referring to FIG. 3, the cooling medium stored in the storage tank 10 is liquified hydrogen.

In addition, the driving motor cooling system may further include a fuel line 320 connected to the outlet pipe 270 of the cooling case 250 and configured to supply, to a fuel cell 310, hydrogen gas produced through phase change of the cooling medium according to heat exchange with the normal conduction driving motor 200, and the fuel cell 310 provided at a side downstream of the normal conduction driving motor 200 and configured to generate driving force using the hydrogen gas phase-changed while cooling the normal conduction driving motor.

Through the above-described additional configuration, the normal conduction driving motor 200 is cooled by liquified hydrogen, and resultant vaporized hydrogen is supplied to the fuel cell 310 and, as such, electrical energy may be produced in the fuel cell 310.

Typically, in a hydrogen vehicle configured to generate driving force using a hydrogen fuel cell, liquified hydrogen is exposed to a heat source through a heat exchanger such that the liquified hydrogen is phase-changed into hydrogen gas, and the hydrogen gas is supplied to the hydrogen fuel cell.

On the other hand, in the present disclosure, liquified hydrogen is phase-changed into hydrogen gas through heat exchange thereof with the normal conduction driving motor 200, and the hydrogen gas is then supplied to the fuel cell 310.

Accordingly, liquefied hydrogen collectively performs a function for cooling the normal conduction driving motor 200 and a function for generating driving force in accordance with supply thereof to the fuel cell 310 in a state of being phase-changed into hydrogen gas and, as such, the liquified hydrogen may be more effectively used.

Meanwhile, the driving motor cooling system according to the other embodiment of the present disclosure may further include a branch line 16 connected to the fuel line 320 after being branched from the control valve 11 of the cooling line 15 and provided with a heat exchanger 300 configured to receive liquified hydrogen from the storage tank 10 and then to vaporize the liquified hydrogen.

That is, the cooling line 15 is connected to the inlet pipe 260, and the branch line 16 branched from the cooling line 15 is connected to the heat exchanger 300. The reason why such connection is provided is because the amount of liquified hydrogen introduced into the normal conduction driving motor 200 is varied in accordance with the reference temperature of the normal conduction driving motor 200. Liquified hydrogen not introduced into the normal conduction driving motor 200 is fed to the heat exchanger 300 via the control valve 11 and the branch line 16. Accordingly, the heat exchanger 300 may phase-change the liquified hydrogen into hydrogen gas and may then supply the hydrogen gas to the fuel cell 310.

Referring to FIG. 3, although liquified hydrogen is partially introduced into the normal conduction driving motor 200, the remaining part of the liquified hydrogen may be introduced into the heat exchanger 300 and may then be vaporized and, as such, the resultant vaporized hydrogen may be introduced into the fuel cell 310 after being joined with vaporized hydrogen discharged from the outlet pipe 270 at a downstream end of the fuel line 320.

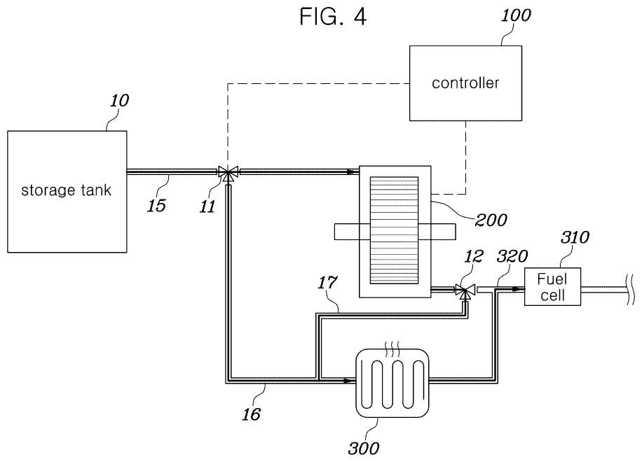

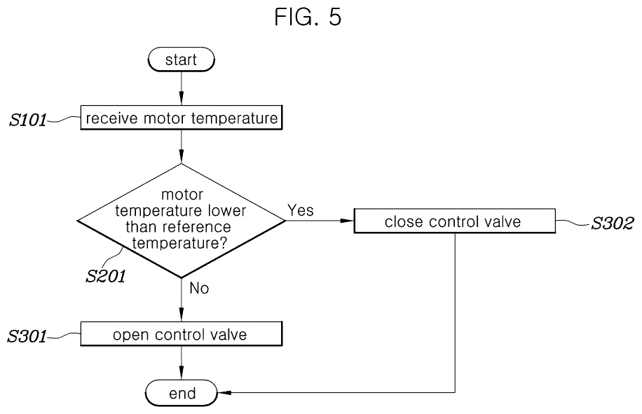

Meanwhile, referring to FIG. 4, a heating line 17 may be branched from the branch line 16 at a side upstream of the heat exchanger 300 in order to guide hydrogen used to cool the normal conduction driving motor 200 such that the hydrogen is introduced into the heat exchanger 300. In addition, a heating valve 12 may be provided at the fuel line 320 at a side upstream of the fuel cell 310, and the heating line 17 may be connected to the fuel line 320 via the heating valve 12.

In addition, when the controller 100 determines that the temperature of the cooling medium used to cool the normal conduction driving motor 200 is lower than a critical temperature, the controller 100 closes a fuel cell-side part of the heating valve 12 while opening a heat exchanger-side part of the heating valve 12, thereby causing the cooling medium used to cool the normal conduction driving motor 200 to be introduced into the heat exchanger 300. In this case, the critical temperature may be a boiling point of hydrogen (−252.7° C.).

In detail, when liquified hydrogen introduced into the normal conduction driving motor 200 has a temperature lower than the boiling point thereof, the liquified hydrogen may be introduced into the fuel line 320. When liquified hydrogen is introduced into the fuel cell 310 through the fuel line 320, failure of the fuel cell 310 may occur.

To this end, the controller 100 determines the temperature of the cooling medium used to cool the normal conduction driving motor 200 in order to open the fuel cell-side part of the heating valve 12 only when the temperature of the cooling medium is determined not to be lower than the boiling point of hydrogen.

When the temperature of the cooling medium used to cool the normal conduction driving motor 200 is determined to be lower than the boiling point of hydrogen, the controller 100 closes the fuel cell-side part of the heating valve 12 and opens only the heat exchanger-side part of the heating valve 12. In this case, liquid hydrogen may be phase-changed in the heat exchanger 300 and, as such, hydrogen gas may be supplied to the fuel cell 310.

Meanwhile, the controller 100 may control the control valve 11 to always open the branch line 16 connected to the heat exchanger 300. In this case, even when the controller 100 closes a part of the control valve 11 at a side of the normal conduction driving motor 200, thereby preventing liquid hydrogen from being supplied to the normal conduction driving motor 200, it may be possible to phase-change liquid hydrogen into hydrogen gas through the heat exchanger 300 and, as such, to continuously supply the hydrogen gas to the fuel cell 310.

Next, the case in which the driving motor 200 is not a normal conduction driving motor, but is a superconducting driving motor, will be described. The superconducting driving motor 200 means a driving motor utilizing a superconducting phenomenon. In more detail, the superconducting phenomenon means that electrical resistance interfering with flow of electric current completely disappears at a critical temperature or less. The superconducting motor uses a superconducting material, and a stator coil of the superconducting motor is constituted by a superconducting coil.

The superconducting driving motor 200 exhibits high efficiency, as compared to the normal conduction driving motor 200. Of course, for utilization of a superconducting phenomenon, lowering the temperature of the superconducting driving motor 200 to the critical temperature or less is most important. To this end, when the cooling system according to the present disclosure is applied to the superconducting driving motor 200, the controller 100 is configured to control a part of the control valve 11 at a side of the superconducting driving motor 200 to be always opened. Accordingly, the driving motor 200 may be continuously maintained at a low temperature through continuous supply of the cooling medium stored in the storage tank 10, in particular, a cryogenic refrigerant, to the cooling case 250 and, as such, a superconducting phenomenon may be realized.

Hereinafter, a control method for a driving motor cooling system according to an embodiment of the present disclosure will be described. The cooling system control method may include receiving, by a controller, a temperature of a normal conduction driving motor (S101), comparing, by the controller, the temperature of the normal conduction driving motor with a reference temperature stored in a memory (S201), and controlling, by the controller, a control valve in accordance with results of comparison between the temperature of the normal conduction driving motor and the reference temperature stored in the memory, thereby controlling cooling of the driving motor (S301 and S302).

Here, the reference temperature stored in the memory may be −200° C. to 50° C. In detail, the reference temperature may be set between −200° C. and 50° C. in accordance with the material of permanent magnets of a rotor, constituent elements or a structure of the normal conduction driving motor, etc.

When the temperature of the normal conduction driving motor is not lower than the reference temperature in the controlling cooling, the controller opens a part of the control valve at a side of the normal conduction driving motor, thereby allowing a cooling medium to be introduced into a cooling case (S301). On the other hand, when the temperature of the normal conduction driving motor is lower than the reference temperature, the controller closes the part of the control valve at the side of the normal conduction driving motor (S302), thereby preventing the cooling medium from being further introduced into the cooling case.

Meanwhile, an embodiment in which a cooling medium stored in a storage tank is liquified hydrogen will be described.

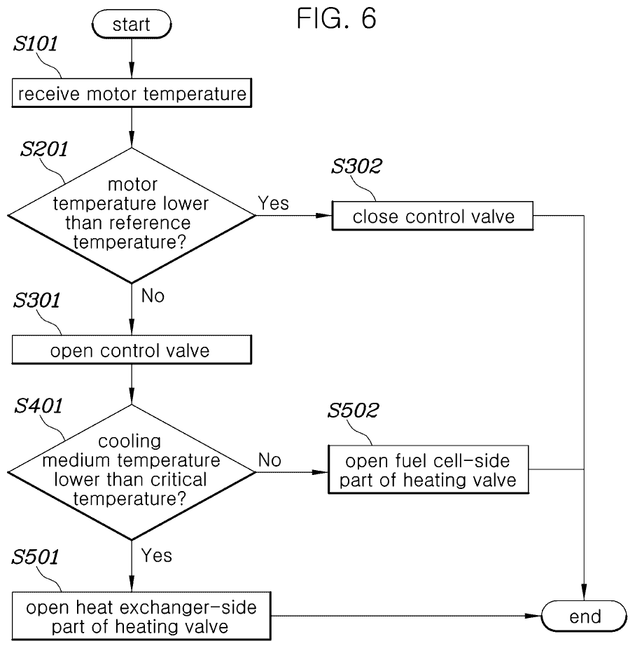

FIG. 6 is a flowchart of a control method for a driving motor cooling system according to another embodiment of the present disclosure.

In accordance with the other embodiment of the present disclosure, the driving motor cooling system further includes a fuel cell provided at a side downstream of the normal conduction driving motor and configured to generate driving force using hydrogen gas phase-changed through cooling of the normal conduction driving motor, a fuel line connected to the outlet pipe of the cooling case and configured to supply, to the fuel cell, hydrogen gas phase-changed through heat exchange thereof with the normal conduction driving motor, a branch line connected to the fuel line after being branched from the control valve of the cooling line and provided with a heat exchanger configured to receive liquefied hydrogen from the storage tank and then to vaporize the liquified hydrogen, and a heating line connected to a heating valve provided at the fuel line after being branched from the branch line at a side upstream of the heat exchanger.

That is, as described above, for more efficient use of the liquified hydrogen, the normal conduction driving motor is cooled through liquefied hydrogen, and electrical energy is generated in the fuel cell using phase-changed hydrogen.

Of course, in accordance with another embodiment, controlling, by the controller, the heating valve based on a temperature of the cooling medium used to cool the normal conduction driving motor (S501 and S502) may be further executed.

That is, as described above, when liquified hydrogen, which is incompletely vaporized, is introduced into the fuel cell, failure of the fuel cell may occur.

To this end, the controller determines whether or not the temperature of the cooling medium is lower than a critical temperature (a boiling point of hydrogen) (S401). Upon determining that the temperature of the cooling medium is lower than the critical temperature, the controller closes the fuel cell-side part of the heating valve and opens the heat exchanger-side part of the heating valve (S501), thereby allowing the cooling medium used to cool the normal conduction driving motor to be introduced into the heat exchanger. In this case, accordingly, the cooling medium may be completely phase-changed.

On the other hand, upon determining that the temperature of the cooling medium is not lower than the critical temperature, the controller closes the heat exchanger-side part of the heating valve and opens only the fuel cell-side part of the heating valve (S502), thereby allowing the cooling medium used to cool the normal conduction driving motor to be directly introduced into the fuel cell. In this case, accordingly, the fuel cell may generate electrical energy.

As apparent from the above description, in accordance with the present disclosure, the cooling case surface-contacts the stator of the driving motor in a circumferential direction of the stator and, as such, the area of the cooling case exchanging heat with the stator may be maximized. As a result, cooling efficiency may be maximized. Accordingly, efficiency enhancement, element stability, specific output enhancement, size reduction, etc. of the driving motor may be satisfied.

In addition, it may be possible to appropriately adjust the amount of the cooling medium introduced into the cooling case in accordance with the temperature of the driving motor through the controller. Accordingly, the state of the driving motor may be optimized.

Furthermore, when a fuel cell is used, liquified hydrogen is phase-changed into hydrogen gas through heat exchange thereof with the driving motor, and the hydrogen gas is supplied to the fuel cell. In accordance with such a configuration, it may be possible to not only reduce a load applied to the heat exchanger, but also to efficiently achieve two functions of the liquified hydrogen, that is, cooling of the driving motor and generation of driving force according to supply to the fuel cell.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

1. A driving motor cooling system comprising:
a storage tank configured to store a cooling medium;
a cooling case configured to surround an outer circumferential surface of a normal conduction driving motor and being formed with a flow space configured to allow the cooling medium to flow therein, and formed with an inlet pipe and an outlet pipe for the cooling medium configured to connect the flow space to an outside;
a cooling line configured to connect the storage tank and the inlet pipe, thereby allowing the cooling medium to be supplied to the cooling case;
a control valve provided at the cooling line; and
a controller comprising a memory storing a reference temperature and being configured to control the control valve through comparison of a temperature of the normal conduction driving motor with the reference temperature, thereby controlling cooling of the normal conduction driving motor through the cooling medium.

2. The driving motor cooling system according to claim 1, wherein the cooling case either directly contacts a stator of the normal conduction driving motor or is adjacent to the stator.

3. The driving motor cooling system according to claim 1, wherein a stator of the normal conduction driving motor is positioned inside a rotor of the normal conduction driving motor, and the cooling case is inserted into an interior of the stator of the normal conduction driving motor.

4. The driving motor cooling system according to claim 1, wherein, when the temperature of the normal conduction driving motor is not higher than the reference temperature, the controller controls a part of the control valve at a side of the normal conduction driving motor to reduce an amount of the cooling medium supplied to the cooling case.

5. The driving motor cooling system according to claim 4, wherein the reference temperature is −200° C. to 50° C.

6. The driving motor cooling system according to claim 1, wherein the inlet pipe is formed at an end of one side of the cooling case, and the outlet pipe is formed at an end of an other side of the cooling case which is opposite to the end of the one side of the cooling case.

7. The driving motor cooling system according to claim 1, wherein the cooling medium stored in the storage tank is selected from a group consisting of liquified hydrogen, liquified nitrogen, liquified helium, liquefied argon, and liquified methane.

8. The driving motor cooling system according to claim 7, wherein:
the cooling medium stored in the storage tank is liquefied hydrogen; and
the driving motor cooling system further comprises:
a fuel cell provided at a side downstream of the normal conduction driving motor and configured to generate driving force using hydrogen gas phase-changed while cooling the normal conduction driving motor; and
a fuel line connected to the outlet pipe of the cooling case and configured to supply, to the fuel cell, the hydrogen gas phase-changed through heat exchange with the normal conduction driving motor.

9. The driving motor cooling system according to claim 8, further comprising:
a branch line connected to the fuel line after being branched from the control valve of the cooling line, and provided with a heat exchanger configured to receive liquified hydrogen from the storage tank and then to vaporize the liquified hydrogen.

10. The driving motor cooling system according to claim 9, wherein:
a heating line is branched from the branch line at a side upstream of the heat exchanger in order to guide hydrogen used to cool the normal conduction driving motor such that the hydrogen is introduced into the heat exchanger; and
a heating valve is provided at the fuel line at a side upstream of the fuel cell, and the heating line is connected to the fuel line via the heating valve.

11. The driving motor cooling system according to claim 10, wherein, upon determining that a temperature of the cooling medium used to cool the normal conduction driving motor is lower than a critical temperature, the controller closes a fuel cell-side part of the heating valve and opens a heat exchanger-side part of the heating valve, thereby allowing the cooling medium used to cool the normal conduction driving motor to be introduced into the heat exchanger.

12. The driving motor cooling system according to claim 11, wherein the critical temperature is a boiling point of hydrogen (−252.7° C.).

13. The driving motor cooling system according to claim 9, wherein the controller controls the control valve such that the branch line connected to the heat exchanger is always open.

14. A driving motor cooling system comprising:
a storage tank configured to store a cooling medium;
a cooling case configured to surround an outer circumferential surface of a driving motor and being formed with a flow space configured to allow the cooling medium to flow therein, and formed with an inlet pipe and an outlet pipe for the cooling medium configured to connect the flow space to an outside;
a cooling line configured to interconnect the storage tank and the inlet pipe, thereby allowing the cooling medium to be supplied to the cooling case;
a control valve provided at the cooling line; and
a controller comprising a memory storing a reference temperature, the controller being configured to control the control valve to always open the cooling line connected to the driving motor when the driving motor is a superconducting driving motor, the controller being configured to control the control valve through comparison of a temperature of the driving motor with the reference temperature, thereby controlling cooling of the driving motor through the cooling medium, when the driving motor is a normal conduction driving motor.

15. A control method for a driving motor cooling system comprising a cooling medium storage tank, a cooling case configured to surround an outer circumferential surface of a normal conduction driving motor and being formed with a flow space therein, and formed with an inlet pipe and an outlet pipe for the cooling medium configured to connect the flow space to an outside, a cooling line configured to interconnect the storage tank and the inlet pipe, a control valve provided at the cooling line, and a controller configured to control the control valve, the control method comprising:
receiving, by the controller, a temperature of the normal conduction driving motor;
comparing, by the controller, the temperature of the normal conduction driving motor with a reference temperature stored in a memory; and
controlling, by the controller, the control valve in accordance with results of comparison between the temperature of the normal conduction driving motor and the reference temperature stored in the memory, thereby controlling cooling of the driving motor.

16. The control method according to claim 15, wherein, when the temperature of the normal conduction driving motor is not higher than the reference temperature in the controlling cooling, the controller closes a part of the control valve at a side of the normal conduction driving motor.

17. The control method according to claim 15, wherein the reference temperature stored in the memory is −200° C. to 50° C.

18. The control method according to claim 15, wherein:
the cooling medium is liquid hydrogen;
the driving motor cooling system further comprises:
a fuel cell provided at a side downstream of the normal conduction driving motor and configured to generate driving force using hydrogen gas phase-changed while cooling the normal conduction driving motor;
a fuel line connected to the outlet pipe of the cooling case and configured to supply, to the fuel cell, the hydrogen gas phase-changed through heat exchange with the normal conduction driving motor;
a branch line connected to the fuel line after being branched from the control valve of the cooling line and provided with a heat exchanger configured to receive liquified hydrogen from the storage tank and then to vaporize the liquified hydrogen; and
a heating line branched from the branch line at a side upstream of the heat exchanger and connected to a heating valve provided at the fuel line;
the control method further comprises controlling, by the controller, the heating valve based on a temperature of the cooling medium used to cool the normal conduction driving motor after the controlling cooling.

19. The control method according to claim 18, wherein, upon determining that the temperature of the cooling medium is lower than a critical temperature in the controlling the heating valve, the controller closes a fuel cell-side part of the heating valve and opens a heat exchanger-side part of the heating valve, thereby allowing the cooling medium used to cool the normal conduction driving motor to be introduced into the heat exchanger.

20. The control method according to claim 19, wherein the critical temperature is a boiling point of hydrogen (−252.7° C.).
